(19) United States
(12) Patent Application Publication
(10) Pub. No.: US 2019/0325146 A1
(43) Pub. Date: Oct. 24, 2019

(54) DATA ENCRYPTION AND DECRYPTION METHOD AND SYSTEM AND NETWORK CONNECTION APPARATUS AND DATA ENCRYPTION AND DECRYPTION METHOD THEREOF

(71) Applicants: ThroughTek Technology (ShenZhen) Co., Ltd., Shenzhen (CN); ThroughTek Co., Ltd., Taipei City (TW)

(72) Inventor: Yeong-Jyi LEI, Taipei City (TW)

(21) Appl. No.: 16/248,976

(22) Filed: Jan. 16, 2019

(30) Foreign Application Priority Data
Apr. 24, 2018 (TW) 107113896

(51) Int. Cl. G06F 21/60; H04L 9/30; H04L 9/14; H04L 9/32; H04L 9/08

(52) U.S. Cl. CPC G06F 21/602; H04L 9/30; H04L 9/0825; H04L 9/3247; H04L 9/0869; H04L 9/14

(57) ABSTRACT

A data encryption and decryption system includes a network connection apparatus and a server. The network connection apparatus includes a main and a sub program modules. The sub program module is configured with a second private key, generates a first asymmetric key group including a first private key and a first public key, and generates a request message through the main program module. The request message includes an encryption data including the first public key and the second private key. When receiving the request message, the server checks the encryption data by using the second public key, obtains a sensitive data according to the request message, obtains the first public key from the request message and encrypts the sensitive data and the first public key to generate a response message. The sub program module decrypts the response message by using the first private key to obtain the sensitive data.

### CROSS REFERENCE TO RELATED APPLICATION

This application claims the priority benefit of Taiwan Patent Application Serial Number 107113896, filed on Apr. 24, 2018, the full disclosure of which is incorporated herein by reference.

### BACKGROUND

### Technical Field

This disclosure generally relates to a data encryption and decryption method and, more particularly, to a data encryption and decryption method and system suitable to a network apparatus and a server and the client terminal and a data encryption and decryption method thereof.

### Related Art

In general, the operation of data transmission is required between the server and the client terminal. The client terminal is configured with a browser, and the browser is configured with a plug-in. Therefore, the user may operate the plug-in through the browser, and the plug-in transmits an unique identifier (UID) and a password used to the connection to the server through the browser, such that the client terminal may be connected to the server for data transmission.

However, since the plug-in needs to be able to transmit the data through the browser, if the system designer sets the server to share, the unique identifier (UID) and the password used to connect the server to the client terminal are exposed by the browser, i.e. the content transmitted by the browser is visible, such that the user may also view the plug-in transmits an unique identifier (UID) and a password used to the connection through the browser, resulting in the problem for the security of data transmission. Therefore, the data transmission between the server and the client terminal needs improvement.

### SUMMARY

The disclosure provides a data encryption and decryption method and system and a network connection apparatus and a data encryption and decryption method thereof, thereby increasing the security of data transmission.

The disclosure provides a data encryption and decryption system including a network connection apparatus and a server. The network connection apparatus includes a main program module and a sub program module, the sub program module is provided with a second private key, the sub program module communicates through the main program module, the sub program module generates a first asymmetric key group, the first asymmetric key group includes a first private key and a first public key, the first private key and the first public key are random, the sub program module generates a request message through the main program module, the request message includes an encryption data, and the encryption data includes the first public key and the second private key. The server includes a second public key, the second public key corresponds to the second private key, when the server receives the request message, the server checks the encryption data by using the second public key and obtains a sensitive data according to the request message after the encryption data is determined as valid, the server obtains the first public key from the request message and performs an encryption operation for the sensitive data and the first public key to generate a response message. The sub program module decrypts the response message by using the first private key to obtain the sensitive data.

The disclosure provides a data encryption and decryption method including the following steps. A first asymmetric key group is generated by a sub program module of a main program module of a network connection apparatus, wherein the first asymmetric key group includes a first private key and a first public key, the first private key and the first public key are random, and the sub program module is provided with a second private key. An encryption data is generated by the sub program module, and a request message including the encryption data is generated to a server through the main program module, wherein the encryption data includes the first public key and the second private key. The encryption data is checked by using a second public key configured in the server and a sensitive data is obtained according to the request message after the encryption data is determined as valid through the server, wherein the second public key corresponds to the second private key. The first public key is obtained from the request message by the server. The sensitive data and the first public key are encrypted to generate a response message and transmitting the response message to the sub program module through the server. The response message is decrypted by using the first private key to obtain the sensitive data through the sub program module.

The disclosure provides a network connection apparatus performing a data transmission through an internet and a server. The networking connection apparatus includes a network module, a main program module and a sub program module. The network module is connected to the internet and communicates with the server. The main program module is connected to the internet and transmits messages through the internet. The sub program module is provided with a second private key, the sub program module communicating with the main program module, and the sub program module generating a first asymmetric key group, wherein the first asymmetric key group includes a first private key and a first public key, the first private key and the first public key are random, the sub program module generates a request message to the server through the main program module, and the sub program module decrypts a response message generated by the server by using the first private key to obtain a sensitive data. The request message includes an encryption data, the encryption data includes the first public key and the second private key, the second private key corresponds to a second public key, and the response message is generated after the server checks the encryption data by using the second public key and obtains the sensitive data according to the request message when the encryption data is determined as valid and the server then encrypts the sensitive data and the first public key obtained from the request message.

The disclosure provides data encryption and decryption system of a network connection apparatus performing a data transmission through an internet and a server. The data encryption and decryption system of the networking connection apparatus includes the following steps. A first asymmetric key group is generated by a sub program module of a main program module of the network connection apparatus, wherein the first asymmetric key group includes a first private key and a first public key, the first private key and the first public key are random, the sub program module is provided with a second private key, and the sub program module communicates through the main program module. An encryption data is generated by the sub program module, and a request message including the encryption data is generated and transmitted to the server through the main program module, wherein the encryption data includes the first public key and the second private key. a response message is encrypted from the server by using the first private key through the sub program module, wherein the response message is generated after the server checks the encryption data by using the second public key and obtains the sensitive data according to the request message when the encryption data is determined as valid and the server then encrypts the sensitive data and the first public key obtained from the request message. The second public key corresponds to the second private key.

According to the data encryption and decryption method and system and the network connection apparatus and the data encryption and decryption method thereof, the sub program module of the main program module of the network connection apparatus generates the first asymmetric key group, wherein the first asymmetric key group includes the first private key and the first public key, the first private key and the first public key are random, the sub program module generates the request message to the server through the main program module, wherein the request message includes the encryption data, and the encryption data includes the first public key and the second private key, and the second private key is configured in the sub program module. Afterward, the server checks the encryption data by using the second public key and obtains the sensitive data according to the request message after the encryption data is determined as valid. The server obtains the first public key from the request message and encrypts the sensitive data and the first public key to generate a response message, such that the sub program module decrypts the response message by using the first private key to obtain the sensitive data. Therefore, the security of data transmission is effectively increased.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows a flowchart of a data encryption and decryption method according to a first exemplary embodiment of the disclosure;

FIG. 2 shows a flowchart of a data encryption and decryption system and a data transmission thereof according to the first exemplary embodiment of the disclosure;

FIG. 3 shows a detailed flowchart of step S104 in FIG. 1;

FIG. 4 shows another detailed flowchart of step S104 in FIG. 1;

FIG. 5 shows a detailed flowchart of step S106 in FIG. 1;

FIG. 6 shows another detailed flowchart of step S106 in FIG. 1;

FIG. 7 shows a flowchart of a data encryption and decryption method of a network connection apparatus according to a second exemplary embodiment of the disclosure.

### DETAILED DESCRIPTION OF THE EMBODIMENTS

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

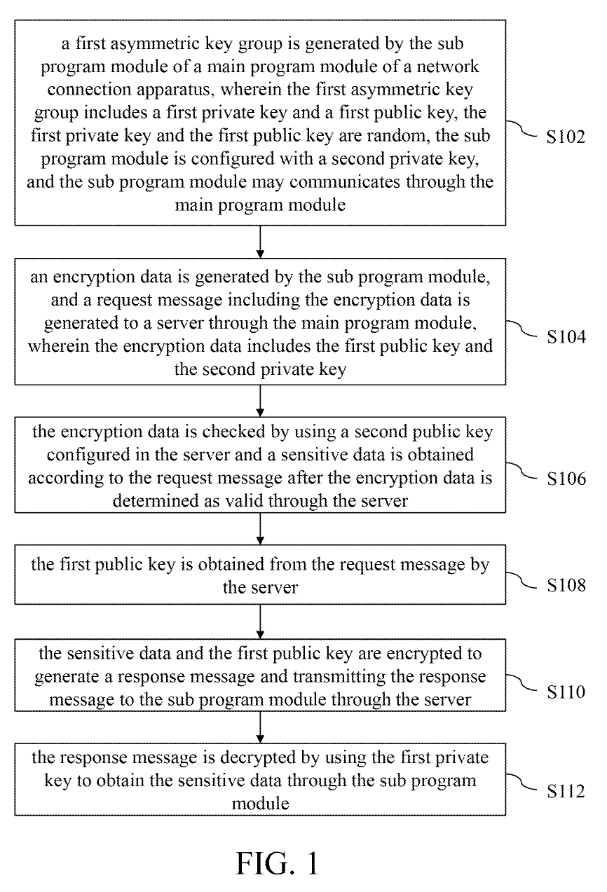

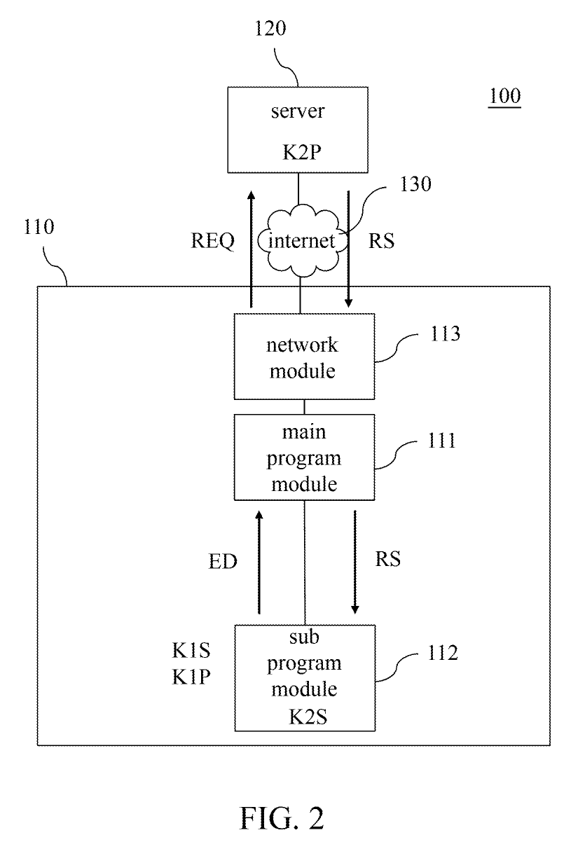

FIG. 1 shows a flowchart of a data encryption and decryption method according to a first exemplary embodiment of the disclosure. FIG. 2 shows a flowchart of a data encryption and decryption system and a data transmission thereof according to the first exemplary embodiment of the disclosure. The data encryption and decryption method in the embodiment is suitable to the data encryption and decryption system 100 including a network connection apparatus 110 and a server 120. That is, the method is used for a data transmission between the network connection apparatus 110 and the server 120. The network connection apparatus 110 may be an operating device, such as a tablet computer, a general desktop or portable computer, etc. The server 120 may be an entity or a virtual device, such as a general entity server machine or a cloud server.

Further, the network connection apparatus 110 may include a main program module 111, a sub program module 112 and a network module 113. The network module 113 is connected to the internet 130 and communicates with the server 120. The main program module 111 is connected to the network module 113 and transmits messages through the internet 130. The sub program module 112 is connected to the main program module 111 and communicates through the main program module 111. In one embodiment, the main program module 111 and the second program module 112 may be a computer software. In another embodiment, the main program module 111 and the sub program module 112 may be circuit modules configured in the same processor.

In step S102, a first asymmetric key group is generated by the sub program module 112 of a main program module 111 of a network connection apparatus 100, wherein the first asymmetric key group includes a first private key K1S and a first public key K1P, the first private key K1S and the first public key K1P are random. In other words, the first private key K1S and the first public key K1P of the generated first asymmetric key group are different each time. The sub program module 112 is configured with a second private key K2S, and the sub program module 112 may communicates through the main program module 111. The action of the sub program module 112 to generate the first asymmetric key group may be to perform a predetermined behavior. For example, in one embodiment, when the network connection apparatus 100 needs the server 120 to transmit the confidential data, the sub program module 112 may generate the first asymmetric key group with randomness, and the time point of generating the first asymmetric key group is not limited thereto. In another embodiment, when the sub program module 112 of the network connected apparatus 110 is started, the sub program module 112 may generate the first asymmetric key group with randomness. The first asymmetric key group generated by the sub program module 112 is random each time, so as to effectively decrease the possibility of data theft.

In step S104, an encryption data ED is generated by the sub program module 112, and a request message REQ including the encryption data ED is generated to a server 120 through the main program module 111, wherein the encryption data ED includes the first public key K1P and the second private key K2S. The first public key K1P of the encryption data ED is generated and provided by the sub program module 112, and the second private key K2S of the encryption data ED is generated by the sub program module 112. That is, in one embodiment, when the sub program module 112 is started (i.e. the user opens the sub program module 112 through the main program module 111), the sub program module 112 may starts the corresponding function and generates the request message REQ to the server 120 through the main program module 111, so as to request the server 120 to obtain the corresponding data. When the main program module 111 generates the request message REQ, the encryption data ED is added to the request message REQ at the same time, i.e. the request message REQ includes the encryption data ED.

In one embodiment, the program module 112 generates a data content according to the first public key K1P, processes the data content by using the second private key K2S, combines the processed date content and the first public key K1P to generate the encryption data ED and transmits the encryption data ED to the main program module 111, such that the main program module 111 generates the request message REQ including the encryption data ED to the server 120 accordingly. Further, the sub program module 112 may, for example, perform an algorithmic operation (such as the operation of the hash function) to obtain an operation result, and multiplies the operation result and the second private key K2S to generate a digital signature code. Then, the sub program module 112 combines the digital signature code and the first public key K1P to generate the encryption data ED.

Additionally, in another embodiment, when the request message REQ is generated according to the encryption data ED, the main program module 111 may further directly embed the encryption ED in the request message REQ and transmit it (i.e. directly transmit the encryption data ED), or perform an enlargement or a format conversion for the content in the encryption data ED and transmit it. That is, after the main program module 111 receives the encryption data ED generated by the sub program module 111, the encryption data ED may be directly embedded in the request message REQ and then transmitted to the server 120, or a format conversion or an enlargement may be further performed for the content of the encryption data ED and the encryption data ED after the format conversion or the enlargement is embedded in the request message REQ, such that the request message REQ is formed as a complete request message and then transmitted to the server 120.

In step S106, the encryption data ED is checked by using a second public key K2P configured in the server 120 and a sensitive data is obtained according to the request message REQ after the encryption data ED is determined as valid through the server 120. For example, when the server 120 receives the request message REQ, the encryption data ED in the request message REQ is acquired firstly. Then, the server 120 checks the encryption data ED by using the second public key K2P configured in the server 120, so as to determines the validity of the encryption data ED. When the encryption data ED is determined as valid, i.e. the second public key K2P is consistent with the encryption data ED, the server 120 may, for example, obtain the corresponding sensitive data from the database thereof according to the request message REQ. When the encryption data ED is determined as invalid, the server 120 does not obtain the sensitive data.

In one embodiment, the sensitive data is, for example, an unique identifier (UID) and password of the network apparatus. The network connection apparatus 110 may be, for example, the user terminal, the network apparatus may be, for example, smart network client terminal (such as smart appliance, IP cam, etc.). The request message transmitted by the network connection apparatus 110 may carry the identity information (such as account number, token) of the user, and the network apparatus may be configured with the identification (ID) information of device itself. The corresponding relationship between the network connection apparatus 110 (i.e. the user) and the network apparatus is bound in the database of the server 120, such as the control authority of the user and the network apparatus. That is, when the server receives the request message, the server may transmits the corresponding apparatus information (such as the identification information of the apparatus operated by the user with authority) to the network apparatus 110 through the network apparatus.

In one embodiment, the sensitive data is, for example, an internet protocol (IP) of the network apparatus. The network connection apparatus 110 may be the user terminal, and the network apparatus may be a smart network client terminal. The network connection apparatus 110 may transmit the request message having the unique identifier (UID) of the network apparatus. The corresponding relationship between the network connection apparatus 110 (i.e. the user) and the network apparatus is bound in the database of the server 120, such as the corresponding relationship between the internet protocol and the unique ID of the network apparatus. When the server receives the request message, the corresponding information (such as the internet protocol of the network apparatus) to the network connection apparatus 110 through the network apparatus, such that the network connection apparatus 110 is connected to the corresponding network apparatus.

In one embodiment, the sensitive data is, for example, a plurality of unique IDs, such as the unique IDs (may further includes the usage authority) of other network apparatuses, and have a corresponding relationship with the token of the user, i.e. the network apparatus has been established the connection with the user (for example, the user has authority to manage/operate network apparatus). Accordingly, when the user changes the used network connection apparatus, the above sensitive data may be also obtained through the server without needing the input setting again. The above token is, for example, provided to the main program module 111 from the server 120 after the user logs in through the main program module 111.

In one embodiment, the user may input the account number information of the user for connecting to the server 120 on the network connection apparatus 110, such that the network connection network 110 is connected to the server 120. After the account number information of the user is bonded to the server 120, the user does not need to input the account number information of the user again in the next connection with the server 120 through the network connection apparatus 110. The request message may carry other information for identifying the user, such as token, the network connection apparatus code, etc. It can be seen that the account number information of the user may also be used as the sensitive data.

Additionally, the second public key K2P and the second private key K2S may be predetermined, wherein the second public key K2P is, for example, configured in the server 120 in advance, and the second private key K2S is, for example, configured in the sub program module 112 of the main program module 111 of the network connection apparatus 110, so as to be used as a digital signature. The second private key K2S and the second public key K2P are formed as a second asymmetric key group. The main program module 111 is, for example, a browser transmitted in a plain code format, and the sub program module 112 is, for example, a plug-in. Further, the information content transmitted by the browser transmitted in the plain code format has a visible nature, and may also, for example, support the additional plug-in, and the browser has the behavior for communicating with the server 120, such that the plug-in may communicates with the server through the browser. The plug-in is, for example, a program added on the browser and it is controlled by the browser.

In step S108, the first public key K1P is obtained from the request message REQ by the server 120. In step S110, the sensitive data and the first public key K1P are encrypted to generate a response message RS and transmitting the response message RS to the sub program module 112 through the server 120. That is, after the server 120 obtains the sensitive data, the server 120 may obtain the first public key K1P from the encryption data ED included in the request message REQ, and encrypt the sensitive data and the first public key K1P to generate the response message RS, wherein the response message RS is, for example, expressed as K1P(Data). Then, the server 120 transmits the response message RS to the main program module 111 of the network connection apparatus 110, the main program module 111 imports the response message RS to the sub program module 112, such that the sub program module performs the subsequent operation.

In step S112, the response message RS is decrypted by using the first private key K1S to obtain the sensitive data through the sub program module 112. That is, When the sub program module 112 obtains the response message RS, the sub program module 112 may firstly obtain the first private key K1S of the interior thereof, and decrypts the response message RS through the first private key K1S, such as K1S(K1P(Data)), so as to obtain the sensitive data from the response message RS.

As can be seen from the above description, during the data transmission between the network connection apparatus 110 and the server 120, when there is a need to require the server 120 to transmit the confidential information or the sub program module 111 is started, the sub program module 112 may generate the first public key K1P and the first private key K1S with randomness and use the second private key K2S and the second public key K2P pre-configured in the network connection apparatus 110 and the server 120, so as to perform a related operation for the data to be transmitted, such as encryption and decryption, digital signature, authentication, etc. Therefore, the security of data transmission is effectively increased.

In the embodiment of FIG. 2, the description is obtaining the encryption data ED in the step S106 and then obtaining the first public key K1P in the step S108, but the embodiment is not limited thereto, i.e. the embodiment does not limit that the encryption data ED is firstly obtained and the first public key K1P is then obtained. In other embodiments, the order of the step S106 and the step S108 may be changed, i.e. the first public key K1P is firstly obtained and the encryption data ED is then obtained, or the step S106 and the step S108 may be combined in the same step.

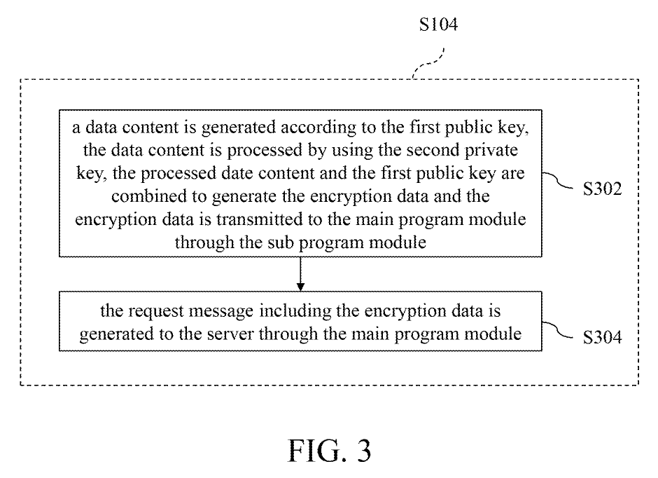

FIG. 3 shows a detailed flowchart of step S104 in FIG. 1. In step S302, a data content is generated according to the first public key K1P, the data content is processed by using the second private key K2S, the processed date content and the first public key K1P are combined to generate the encryption data ED and the encryption data ED is transmitted to the main program module 111 through the sub program module 112. In the embodiment, the sub program module 112 performs, for example, an algorithmic operation (such as the operation of the has function) for the first public key K1P to obtain the data content (hash(K1P)), multiplies the data content and the second private key K2S to generate the digital signature code (K2S(hash(K1P))), and combines the digital signature code and the first public key K1P to generate the encryption data ED (K2S(hash(K1P))+K1P).

In step S304, the request message REQ including the encryption data ED is generated to the server 120 through the main program module 111. That is, the main program module 111 receives the encryption data ED generated by the sub program module 112, the main program module 111 may accordingly generate the request message REQ to the server 120, so as to require the server 120 to obtain the corresponding data. When the main program module 111 generates the request message REQ including the encryption data ED, the request message REQ may include the encryption data ED and may further includes other information, such as the message for requiring to obtain the data, the user identity, etc.

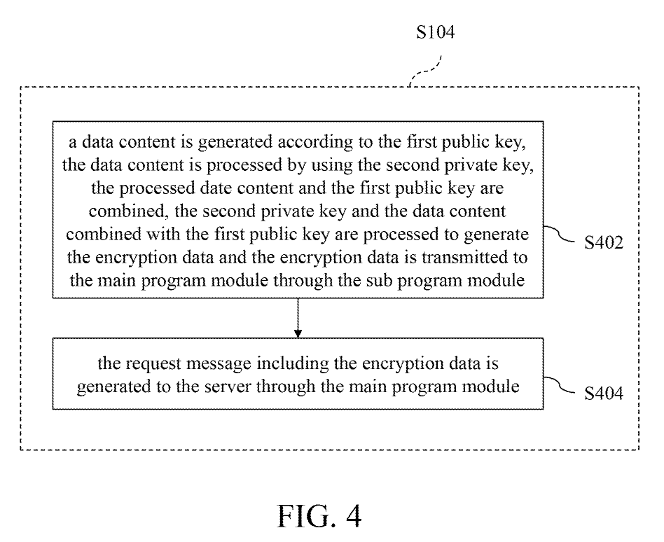

FIG. 4 shows another detailed flowchart of step S104 in FIG. 1. In step S402, a data content is generated according to the first public key K1P, the data content is processed by using the second private key K2S, the processed date content and the first public key K1P are combined, the second private key K2S and the data content combined with the first public key K1P are processed to generate the encryption data ED and the encryption data ED is transmitted to the main program module 111 through the sub program module 112. In the embodiment, the sub program module 112 performs, for example, an algorithmic operation (such as the operation of the has function) for the first public key K1P to obtain the data content (hash(K1P)), multiplies the data content and the second private key K2S to generate the digital signature code (K2S(hash(K1P))), combines the digital signature code and the first public key K1P are combined (K2S(hash(K1P))+K1P)), and multiplies the second private key K2S and the digital signature code combined with the first public key K1P to generate the encryption data ED (K2S(K2S(hash(K1P))+K1P)). the second private key K2S and the digital signature code combined with the first public key K1P are multiplied, thereby further increasing the encryption effect of the encryption data ED and effectively decreasing the possibility of data theft.

In step S404, the request message REQ including the encryption data ED is generated to the server 120 through the main program module 111. That is, the main program module 111 receives the encryption data ED generated by the sub program module 112, the main program module 111 may accordingly generate the request message REQ to the server 120, so as to require the server 120 to obtain the corresponding data. When the main program module 111 generates the request message REQ including the encryption data ED, the request message REQ may include the encryption data ED and may further includes other information, such as the message for requiring to obtain the data, the user identity, etc.

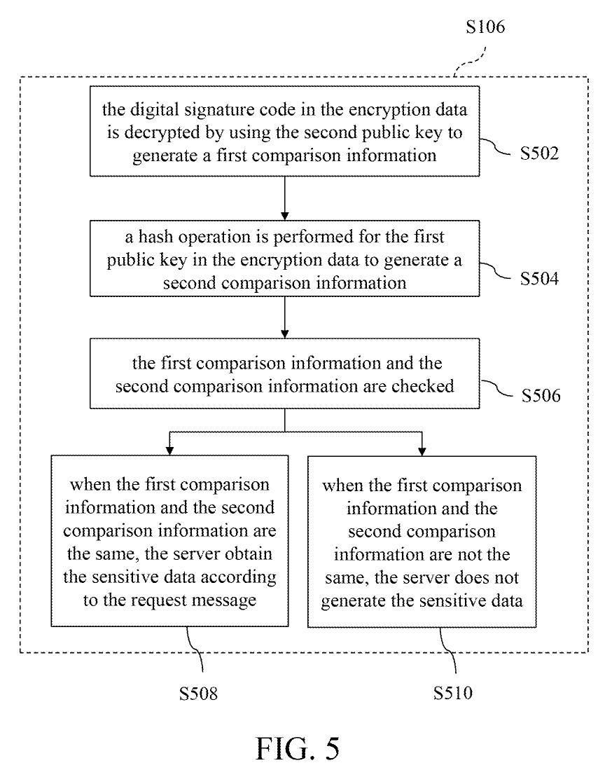

FIG. 5 shows a detailed flowchart of step S106 in FIG. 1, for example, continued with the step S304 of FIG. 3. In step S502, the digital signature code in the encryption data ED is decrypted by using the second public key K2P to generate a first comparison information. That is, the server 120 decrypts the digital signature code (i.e. K2S(hash(K1P))) in the encryption code ED as, for example, K2P(K2S(hash(K1P))) through the second public key K2P, so as to obtain the first comparison information, such as hash(K1P).

In step S504, a hash operation is performed for the first public key K1P in the encryption data ED to generate a second comparison information. That is, the server 120 acquires the first public key K1P from the encryption data ED, and performs an operation of hash function for the first public key K1P to generate the second comparison information, such as hash(K1P). Further, the operation of the hash function used by the server 120 corresponds to the operation of the hash function used by the sub program module 112, i.e. the server 120 and the sub program module 112 use the same operation of the hash function. The above operation of the hash function may be preset in the sub program module 112 and the server 112, or the server 120 may further simultaneously update the above operation of the hash function in sub program module 112 and the server 120 in period and at any time.

In step S506, the first comparison information and the second comparison information are checked. That is, the server 120 may check whether the first comparison information and the second comparison information are the same.

In step S508, when the first comparison information and the second comparison information are the same, the server 120 obtain the sensitive data according to the request message REQ. That is, when the first comparison information and the second comparison information are the same (such as hash(K1P)), the server 120 may, for example, obtain the corresponding sensitive data from the database thereof according to the request message REQ.

In step S510, when the first comparison information and the second comparison information are not the same, the server 120 does not generate the sensitive data. That is, the first comparison information and the second comparison information generated by decrypting the digital signature code through the server are different (i.e. the first comparison information is not hash(K1P) or the second comparison information is not hash(K1P)), it indicates that the server 120 receives the wrong information, the server 120 does not generate the sensitive data. Therefore, the security of data transmission may be effectively increased.

In the above embodiment, the step S502 is firstly performed, and the step S504 is then performed, but the disclosure is not limited thereto. The performing order of the step S502 and the step S504 may be changed, i.e. the step S504 is firstly performed, and the step S502 is then performed, or the step S502 and the step S504 may be simultaneously performed, thus they may achieve the same effect.

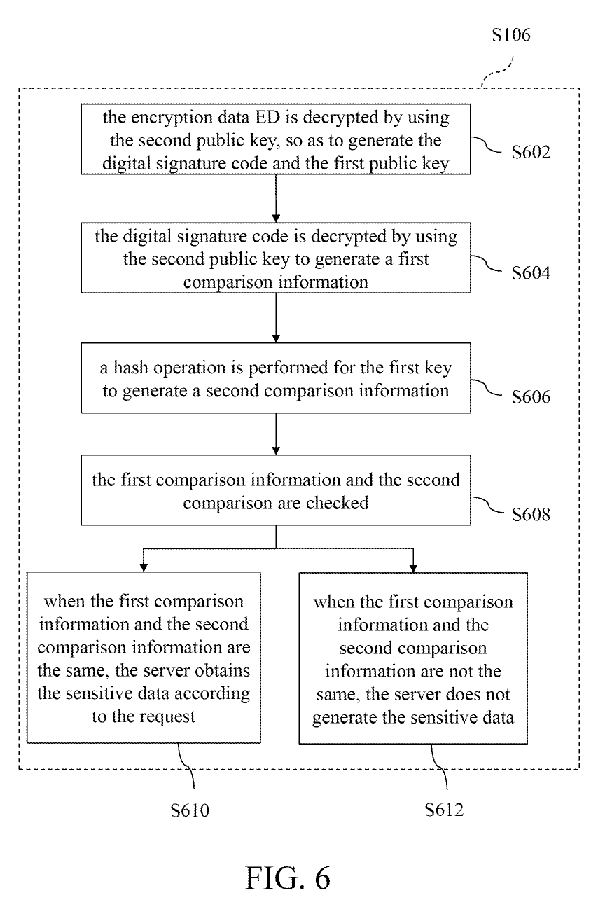

FIG. 6 shows another detailed flowchart of step S106 in FIG. 1, for example, continued with the step S404 in FIG. 4. In step S602, the encryption data ED is decrypted as, for example, K2P(K2S(K2S(hash(K1P))+K1P)) by using the second public key K2P, so as to generate the digital signature code and the first public key, i.e. (K2S(hash(K1P))+K1P).

In step S604, the digital signature code is decrypted by using the second public key K2P to generate a first comparison information. That is, the server 120 decrypts the digital signature code (i.e. K2S(hash(K1P))) as, for example, K2P(K2S(hash(K1P))) through the second public key K2P, so as to obtain the first comparison information, such as hash(K1P).

In step S606, a hash operation is performed for the first key K1P obtained by the step S602 to generate a second comparison information. That is, the server 120 performs an operation of the hash function for the first public key K1P obtained from the encryption data ED, so as to generate the second comparison information, such as hash(K1P).

In step S608, the first comparison information and the second comparison are checked. That is, the server 120 may check whether the first comparison information and the second comparison information are the same.

In step S610, when the first comparison information and the second comparison information are the same, the server 120 obtains the sensitive data according to the request message REQ. That is, when the first comparison information and the second comparison information are the same (such as hash(K1P)), the server 120 may, for example, obtain the corresponding sensitive data from the database thereof according to the request message REQ.

In step S612, when the first comparison information and the second comparison information are not the same, the server 120 does not generate the sensitive data. That is, the first comparison information and the second comparison information generated by decrypting the digital signature code through the server 120 are different (i.e. the first comparison information is not hash(K1P) or the second comparison information is not hash(K1P)), it indicates that the server 120 receives the wrong information, the server 120 does not generate the sensitive data. Therefore, the security of data transmission may be effectively increased.

In the above embodiment, the step S604 is firstly performed, and the step S606 is then performed, but the disclosure is not limited thereto. The performing order of the step S604 and the step S606 may be changed, i.e. the step S606 is firstly performed, and the step S604 is then performed, or the step S604 and the step S606 may be simultaneously performed, thus they may achieve the same effect.

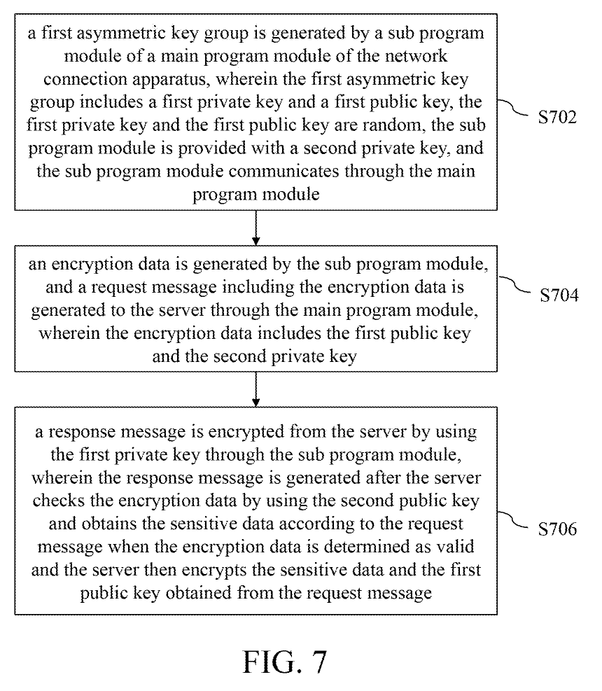

FIG. 7 shows a flowchart of a data encryption and decryption method of a network connection apparatus according to a second exemplary embodiment of the disclosure. The data encryption and decryption method of a network connection apparatus in the embodiment is suitable to communicate with the server. The server is configured with a second public key. The corresponding relationship between the network connection apparatus and the server may be referred to FIG. 2, and the description thereof is omitted.

In step S702, a first asymmetric key group is generated by a sub program module of a main program module of the network connection apparatus, wherein the first asymmetric key group includes a first private key and a first public key, the first private key and the first public key are random, the sub program module is provided with a second private key, and the sub program module communicates through the main program module.

In step S704, an encryption data is generated by the sub program module, and a request message including the encryption data is generated to the server through the main program module, wherein the encryption data includes the first public key and the second private key. Further, the main program module is a browser transmitted in a plain code format, and the sub program module is a plug-in.

In step S706, a response message is encrypted from the server by using the first private key through the sub program module, wherein the response message is generated after the server checks the encryption data by using the second public key and obtains the sensitive data according to the request message when the encryption data is determined as valid and the server then encrypts the sensitive data and the first public key obtained from the request message.

According to According to the data encryption and decryption method and system and the network connection apparatus and the data encryption and decryption method thereof, the sub program module of the main program module of the network connection apparatus generates the first asymmetric key group, wherein the first asymmetric key group includes the first private key and the first public key, the first private key and the first public key are random, the sub program module generates the request message to the server through the main program module, wherein the request message includes the encryption data, and the encryption data includes the first public key and the second private key, and the second private key is configured in the sub program module. Afterward, the server checks the encryption data by using the second public key and obtains the sensitive data according to the request message after the encryption data is determined as valid. The server obtains the first public key from the request message and encrypts the sensitive data and the first public key to generate a response message, such that the sub program module decrypts the response message by using the first private key to obtain the sensitive data. Therefore, the security of data transmission is effectively increased.

Although the disclosure has been explained in relation to its preferred embodiment, it does not intend to limit the disclosure. It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A data encryption and decryption system, comprising:
a network connection apparatus, wherein the network connection apparatus comprises a main program module and a sub program module, the sub program module is provided with a second private key, the sub program module communicates through the main program module, the sub program module generates a first asymmetric key group, the first asymmetric key group comprises a first private key and a first public key, the first private key and the first public key are random, the sub program module generates a request message through the main program module, the request message comprises an encryption data, and the encryption data comprises the first public key and the second private key; and
a server, wherein the server comprises a second public key, the second public key corresponds to the second private key, when the server receives the request message, the server checks the encryption data by using the second public key and obtains a sensitive data according to the request message after the encryption data is determined as valid, the server obtains the first public key from the request message and performs an encryption operation for the sensitive data and the first public key to generate a response message;
wherein the sub program module decrypts the response message by using the first private key to obtain the sensitive data.

2. The data encryption and decryption system as claimed in claim 1, wherein the sub program module generates a data content according to the first public key, processes the data content by using the second private key, combines the processed date content and the first public key to generate the encryption data and transmits the encryption data to the main program module, and the main program module generates the request message comprising the encryption data to the server.

3. The data encryption and decryption system as claimed in claim 2, wherein the sub program module performs an algorithmic operation for the first public key to obtain the data content, multiplies the data content and the second private key to generate a digital signature code, and combines the digital signature code and the first public key to generate the encryption data.

4. The data encryption and decryption system as claimed in claim 3, wherein the server further decrypts the digital signature code in the encryption data by using the second public key to generate a first comparison information, the server further performs a hash operation for the first public key in the encryption to generate a second comparison information, checks the first comparison information and the second comparison information, and the server obtains the sensitive data according to the request massage when the first comparison information and the second comparison information are the same.

5. The data encryption and decryption system as claimed in claim 3, wherein the sub program module combines the digital signature code and the first public key and multiplies the second private key and the digital signature code combined with the first public key, so as to generate the encryption data.

6. The data encryption and decryption system as claimed in claim 5, wherein the server further decrypts the encryption data by using the second public key to obtain the digital signature code and the first public key in the encryption data, the server then decrypts the digital signature code by using the second public key to generate a first comparison information, the server performs a hash operation for the first public key to generate a second comparison information, the server checks the first comparison information and the second comparison information, and the server obtains the sensitive data according to the request message when the first comparison information and the second comparison information are the same.

7. The data encryption and decryption system as claimed in claim 1, wherein the main program module is a browser transmitted in a plain code format, and the sub program module is a plug-in.

8. A data encryption and decryption method, comprising:
generating a first asymmetric key group by a sub program module of a main program module of a network connection apparatus, wherein the first asymmetric key group comprises a first private key and a first public key, the first private key and the first public key are random, and the sub program module is provided with a second private key;
generating an encryption data by the sub program module, and generating a request message comprising the encryption data to a server through the main program module, wherein the encryption data comprises the first public key and the second private key;
checking the encryption data by using a second public key configured in the server and obtaining a sensitive data according to the request message after the encryption data is determined as valid through the server, wherein the second public key corresponds to the second private key;
obtaining the first public key from the request message by the server;
encrypting the sensitive data and the first public key to generate a response message and transmitting the response message to the sub program module through the server; and
decrypting the response message by using the first private key to obtain the sensitive data through the sub program module.

9. The data encryption and decryption method as claimed in claim 8, wherein the step of generating the encryption data by the sub program module comprises:
generating a data content according to the first public key, processing the data content by using the second private key, combining the processed date content and the first public key to generate the encryption data and transmitting the encryption data to the main program module through the sub program module.

10. The data encryption and decryption method as claimed in claim 9, wherein the step of generating a data content according to the first public key, processing the data content by using the second private key, combining the processed date content and the first public key to generate the encryption data comprises:
performing an algorithmic operation for the first public key to obtain the data content, multiplying the data content and the second private key to generate a digital signature code, and combining the digital signature code and the first public key to generate the encryption data.

11. The data encryption and decryption method as claimed in claim 6, wherein the step of checking the encryption data by using the second public key configured in the server and obtaining the sensitive data according to the request message after the encryption data is determined as valid through the server comprises:
decrypting the digital signature code in the encryption data by using the second public key to generate a first comparison information;
performing a hash operation for the first public key in the encryption to generate a second comparison information;
checking the first comparison information and the second comparison information; and
obtaining the sensitive data according to the request massage through the server when the first comparison information and the second comparison information are the same.

12. The data encryption and decryption method as claimed in claim 10, wherein after the step of combining the digital signature code and the first public key further comprises multiplying the second private key and the digital signature code combined with the first public key to generate the encryption data.

13. The data encryption and decryption method as claimed in claim 12, wherein the step of checking the encryption data by using the second public key configured in the server and obtaining the sensitive data according to the request message after the encryption data is determined as valid through the server comprises:
decrypting the encryption data by using the second public key to obtain the digital signature code and the first public key in the encryption data;
decrypting the digital signature code by using the second public key to generate a first comparison information;
performing a hash operation for the first public key to generate a second comparison information and checking the first comparison information and the second comparison information; and
obtaining the sensitive data according to the request message through the server when the first comparison information and the second comparison information are the same.

14. A network connection apparatus, performing a data transmission through an internet and a server, and the networking connection apparatus comprising:
a network module, connected to the internet and communicating with the server;
a main program module, connected to the network module and transmitting messages through the internet; and
a sub program module, provided with a second private key, the sub program module communicating with the main program module, and the sub program module generating a first asymmetric key group, wherein the first asymmetric key group comprises a first private key and a first public key, the first private key and the first public key are random, the sub program module generates a request message to the server through the main program module, and the sub program module decrypts a response message generated by the server by using the first private key to obtain a sensitive data;
wherein the request message comprises an encryption data, the encryption data comprises the first public key and the second private key, the second private key corresponds to a second public key, and the response message is generated after the server checks the encryption data by using the second public key and obtains the sensitive data according to the request message when the encryption data is determined as valid and the server then encrypts the sensitive data and the first public key obtained from the request message.

15. The network connection apparatus as claimed in claim 14, wherein the sub program module generates a data content according to the first public key, processes the data content by using the second private key, combines the processed date content and the first public key to generate the encryption data and transmits the encryption data to the main program module, and the main program module generates the request message comprising the encryption data to the server.

16. The network connection apparatus as claimed in claim 15, wherein the sub program module performs an algorithmic operation for the first public key to obtain the data content, performing an algorithmic operation for the data content and the second private key to generate a digital signature code, and combines the digital signature code and the first public key to generate the encryption data.

17. The network connection apparatus as claimed in claim 16, wherein the sub program module combines the digital signature code and the first public key and multiplies the second private key and the digital signature code combined with the first public key, so as to generate the encryption data.

18. The network connection apparatus as claimed in claim 14, wherein the main program module is a browser transmitted in a plain code format, and the sub program module is a plug-in.

19. A data encryption and decryption system of a network connection apparatus, performing a data transmission through an internet and a server, and the data encryption and decryption system of the networking connection apparatus comprising:
generating a first asymmetric key group by a sub program module of a main program module of the network connection apparatus, wherein the first asymmetric key group comprises a first private key and a first public key, the first private key and the first public key are random, the sub program module is provided with a second private key, and the sub program module communicates through the main program module;
generating an encryption data by the sub program module, and generating and transmitting a request message comprising the encryption data to the server through the main program module, wherein the encryption data comprises the first public key and the second private key; and
encrypting a response message from the server by using the first private key through the sub program module, wherein the response message is generated after the server checks the encryption data by using the second public key and obtains the sensitive data according to the request message when the encryption data is determined as valid and the server then encrypts the sensitive data and the first public key obtained from the request message;
wherein the second public key corresponds to the second private key.

20. The data encryption and decryption system of the networking connection apparatus as claimed in claim 19, wherein the step of generating the encryption data by the sub program module comprises:
generating a data content according to the first public key, processing the data content by using the second private key, combining the processed date content and the first public key to generate the encryption data and transmitting the encryption data to the main program module through the sub program module.

21. The data encryption and decryption system of the networking connection apparatus as claimed in claim 20, wherein the step of generating the data content according to the first public key, processing the data content by using the second private key, combining the processed date content and the first public key to generate the encryption data comprises:
performing an algorithmic operation for the first public key to obtain the data content, performing an algorithmic operation for the data content and the second private key to generate a digital signature code, and combining the digital signature code and the first public key to generate the encryption data.

22. The data encryption and decryption system of the networking connection apparatus as claimed in claim 21, wherein after the step of combining the digital signature code and the first public key further comprises multiplying the second private key and the digital signature key combined with the first public key to generate the encryption data.

23. The data encryption and decryption system of the networking connection apparatus as claimed in claim 19, wherein the main program module is a browser transmitted in a plain code format, and the sub program module is a plug-in.
